(19) United States
(12) Patent Application Publication
(10) Pub. No.: US 2019/0044309 A1
(43) Pub. Date: Feb. 7, 2019

(54) METHOD FOR MANUFACTURING SPARK PLUG

(71) Applicant: NGK SPARK PLUG CO., LTD., Nagoya-shi (JP)

(72) Inventors: Takeshi ITO, Komaki-shi (JP); Norihide KACHIKAWA, Seto-shi (JP)

(73) Assignee: NGK SPARK PLUG CO., LTD., Nagoya-shi (JP)

(21) Appl. No.: 16/038,321

(22) Filed: Jul. 18, 2018

(30) Foreign Application Priority Data
Aug. 1, 2017 (JP) 2017-148826

(51) Int. Cl. H01T 21/02; H01T 13/32; H01T 13/39

(52) U.S. Cl. CPC H01T 21/02; H01T 13/39; H01T 13/32

(57) ABSTRACT

A method for manufacturing the spark plug comprising bending a ground electrode that is joined to a metal shell, along a first die, the first die having an end portion to be pressed against an inner surface of the ground electrode, and a flat surface portion contiguous to the end portion via a curved portion bulging outward, the flat surface portion being formed to be orthogonal to an axial line and includes a first step of pressing the end portion of the first die against the ground electrode.

### RELATED APPLICATIONS

This application claims the benefit of Japanese Patent Application No. 2017-148826, filed Aug. 1, 2017, the entire content of which is incorporated herein by reference.

### FIELD OF THE INVENTION

The present invention relates to a method for manufacturing a spark plug, and particularly to a method for manufacturing a spark plug including a bent ground electrode.

### BACKGROUND OF THE INVENTION

In a general spark plug mounted to an internal combustion engine, a bent ground electrode joined to a metal shell and a center electrode are opposed to each other with a spark gap interposed therebetween. The dimension of the spark gap influences a required voltage for causing a spark discharge, and thus, it is desirable that a dimensional tolerance for the spark gap is small. Japanese Patent Application Laid-Open (kokai) No. 2014-157769 discloses a technique in which a first die is disposed at a distance from the inner surface of a ground electrode, and a second die pressed against the outer surface of the ground electrode is moved toward the first die, thereby bending the ground electrode until the inner surface of the ground electrode comes into contact with the first die.

However, with the above-described conventional technique, a starting point from which the ground electrode starts to be bent is not determined, and thus, variation in the position of the starting point is increased. A problem arises that it is difficult to reduce a dimensional tolerance for the spark gap, owing to the degree of the variation.

The present invention has been conceived in order to address the above-described problem. An advantage of the present invention is a method for manufacturing a spark plug, the method enabling reduction in a dimensional tolerance for a spark gap.

### SUMMARY OF THE INVENTION

In accordance with a first aspect of the present invention, there is provided a method for manufacturing a spark plug including: a tubular metal shell extending in a direction of an axial line from a front side toward a rear side; an insulator disposed in a tube hole of the metal shell and holding a center electrode at the front side; and a rod-like ground electrode having a first end portion joined to a front end portion of the metal shell, and having a second end portion bent to an axial line side so as to be opposed to the center electrode. The method for manufacturing the spark plug according to the present invention includes: a preparation step of preparing the metal shell having the ground electrode joined thereto; and a bending step of bending the ground electrode joined to the metal shell, along a first die to the axial line side. The first die has: an end portion to be pressed against an inner surface of the ground electrode; and a flat surface portion contiguous to the end portion via a curved portion bulging outward. The flat surface portion is formed so as to be orthogonal to the axial line or so as to be tilted to a first end portion side, toward the inner surface of the ground electrode. The bending step includes a first step of pressing the end portion of the first die against the ground electrode.

### Effects of the Invention

In the method for manufacturing the spark plug according to the first aspect, the end portion of the first die is pressed against the ground electrode joined to the metal shell by the first step of the bending step. The first die has the end portion to be pressed against the inner surface of the ground electrode, and the flat surface portion contiguous to the end portion via the curved portion bulging outward. The flat surface portion is formed so as to be orthogonal to the axial line or so as to be tilted to the first end portion side, toward the inner surface of the ground electrode. Since the ground electrode is bent along the first die to the axial line side by the bending step, a starting point from which the ground electrode starts to be bent is determined in accordance with the end portion of the first die. Therefore, a dimensional tolerance for the spark gap can be reduced.

In accordance with a second aspect of the present invention, there is provided a method for manufacturing the spark plug as described above, wherein the ground electrode is bent with use of a second die which is a roller in a second step. The second die is rolled on an outer surface, of the ground electrode, which is a surface on a side opposite to the inner surface toward the second end portion while pressing the outer surface, such that the ground electrode is fitted along the flat surface portion with the end portion of the first die acting as a fulcrum. A position at which the second die is first pressed against the ground electrode in the second step is a position that is closer, in the direction of the axial line, to the second end portion than a position at which the end portion of the first die is pressed. Therefore, in addition to the effect in the first aspect, the ground electrode can be prevented from being squashed between the first die and the second die when the second die is first pressed against the ground electrode.

In accordance with a third aspect of the present invention, there is provided a method for manufacturing the spark plug as described above, wherein the position at which the second die is first pressed against the ground electrode in the second step is a position that is closer, in the direction of the axial line, to the second end portion than a boundary between the curved portion and the flat surface portion. The distance between the end portion of the first die and the position at which the second die is first pressed against the ground electrode, can be elongated as compared with a case where the position at which the second die is first pressed against the ground electrode is a position that is closer, in the direction of the axial line, to the first end portion than the boundary between the curved portion and the flat surface portion. Therefore, in addition to the effect in the second aspect, the ground electrode can be easily bent with the end portion of the first die acting as a fulcrum.

In accordance with a fourth aspect of the present invention, there is provided a method for manufacturing the spark plug as described above, wherein the position at which the second die is first pressed against the ground electrode in the second step is a position that is closer to the first end portion than a position in the direction of the axial line at which an end on a second end portion side of the ground electrode is to be located when an entirety of a part, of the inner surface of the ground electrode, from a position of contact with the end portion of the first die to an end on the second end portion side comes into contact with the first die. As a result, the ground electrode can be pressed against the first die from the first end portion side to the second end portion side, whereby the ground electrode can be bent with high accuracy so as to be fitted along the first die in addition to the effect in the second or third aspect.

### BRIEF DESCRIPTION OF THE DRAWINGS

FIG. 1 is a half sectional view of a spark plug according to one embodiment of the present invention.

FIG. 2 is a side view of a first die and a second die according to a first embodiment.

FIG. 3 is a side view of the first die of which an end portion is pressed against a ground electrode, and the second die.

FIG. 4 is a side view of the first die and the second die pressed against the ground electrode.

FIG. 5 is a side view of the ground electrode with a spark gap being adjusted.

FIG. 6 is a side view of a first die and the second die according to a second embodiment.

### DETAILED DESCRIPTION OF THE INVENTION

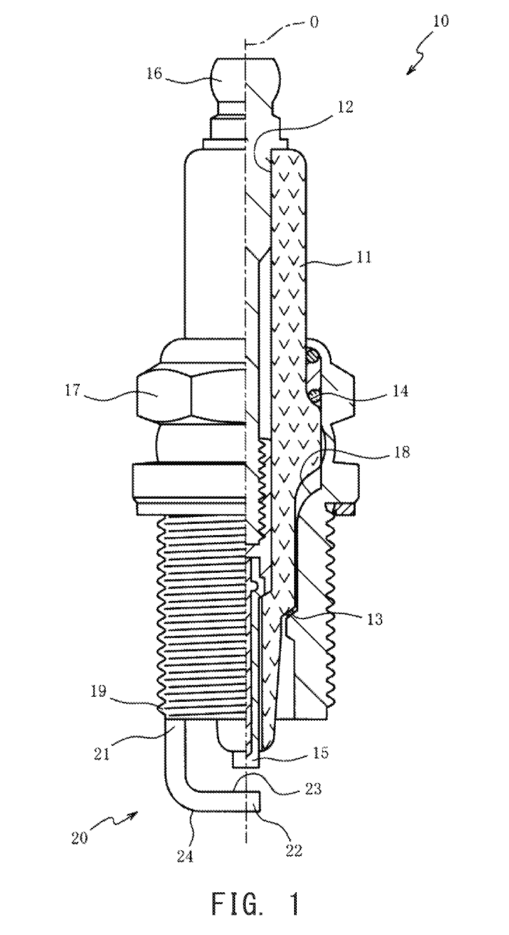

Hereinafter, preferred embodiments of the present invention will be described with reference to the accompanying drawings. FIG. 1 is a half sectional view of a spark plug 10 according to one embodiment of the present invention, with an axial line O thereof as a boundary. In FIG. 1, the lower side of the drawing sheet is referred to as a front side of the spark plug 10, and the upper side of the drawing sheet is referred to as a rear side of the spark plug 10. The spark plug 10 includes an insulator 11, a center electrode 15, a metal shell 17, and a ground electrode 20.

The insulator 11 is a cylindrical member formed from alumina or the like having excellent mechanical property and insulation property at high temperature, and has an axial hole 12 formed so as to penetrate therethrough along the axial line O. The insulator 11 has an outer circumferential surface on which a first fitted portion 13 which is a tilted surface facing the front side and a second fitted portion 14 which is a tilted surface facing the rear side are formed. The center electrode 15 is disposed on the front side of the axial hole 12.

The center electrode 15 is a rod-like member extending along the axial line O, and is obtained by coating, with nickel or a nickel-based alloy, a core material made from copper or a core material containing copper as a main component, for example. The center electrode 15 is held by the insulator 11, and has a front end exposed from the axial hole 12.

A metal terminal 16 is a rod-like member to which a high-voltage cable (not shown) is connected, and is formed from a conductive metal material (e.g., low-carbon steel). The metal terminal 16 is fixed to the rear end of the insulator 11 in a state where the front side thereof is inserted in the axial hole 12. In the axial hole 12, the metal terminal 16 is electrically connected to the center electrode 15. The metal shell 17 is fixed to the outer circumference of the insulator 11.

The metal shell 17 is a substantially cylindrical member formed from a conductive metal material (e.g., low-carbon steel). An axial line O of the metal shell 17 is positioned on the axial line O of the spark plug 10. In the metal shell 17, the first fitted portion 13 and the second fitted portion 14 of the insulator 11 inserted in a tube hole 18 of the metal shell 17 are sandwiched from respective opposed sides in the direction of the axial line O so that the insulator 11 is held from the outer circumference side. The ground electrode 20 is joined to a front end portion 19 of the metal shell 17.

The ground electrode 20 is a rod-like member formed from a metal (e.g., nickel-based alloy), a first end portion 21 of the ground electrode 20 is joined to the front end portion 19 of the metal shell 17, and a second end portion 22 of the ground electrode 20 is opposed to the center electrode 15 with a spark gap interposed therebetween. The ground electrode 20 is bent such that an inner surface 23 thereof faces the center electrode 15 side and an outer surface 24 thereof faces outward.

The spark plug 10 is manufactured by the following method, for example. First, the center electrode 15 is inserted in the axial hole 12 of the insulator 11, and is disposed such that the front end of the center electrode 15 is exposed from the axial hole 12 to the outside. The metal terminal 16 is inserted in the axial hole 12 so that electric conduction between the metal terminal 16 and the center electrode 15 is ensured, and thereafter, the metal shell 17 having the ground electrode 20 joined thereto in advance is assembled to the outer circumference of the insulator 11. The ground electrode 20 is bent such that the second end portion 22 of the ground electrode 20 is opposed to the center electrode 15, thereby obtaining the spark plug 10.

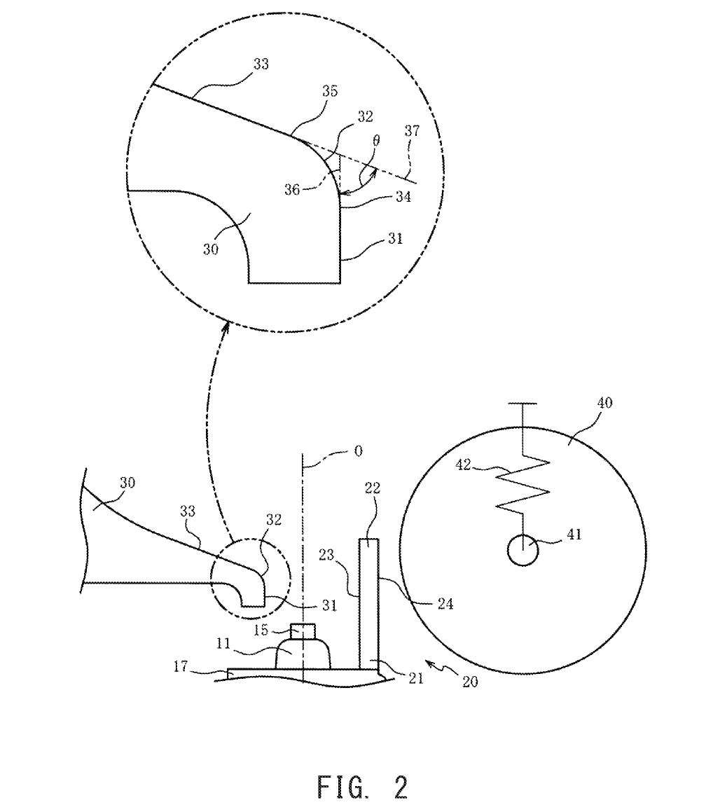

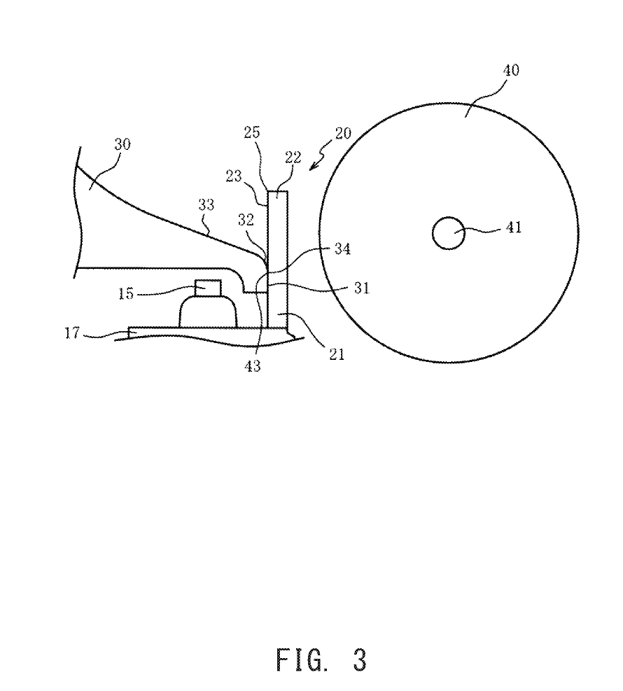

A method for bending the ground electrode 20 will be described with reference to FIG. 2 to FIG. 6. In FIG. 2 to FIG. 6, the upper side of the drawing sheet is referred to as the front side in the direction of the axial line O of the metal shell 17, and the lower side of the drawing sheet is referred to as the rear side in the direction of the axial line O of the metal shell 17. First, a first die 30 and a second die 40 for bending the ground electrode 20 will be described with reference to FIG. 2. FIG. 2 is a side view of the first die 30 and the second die 40 according to a first embodiment. In FIG. 2, an external thread of the metal shell 17 is not shown (the same applies to FIG. 3 to FIG. 6).

The first die 30 and the second die 40 are members for bending the ground electrode 20. The first die 30 and the second die 40 can be moved to respective arbitrary positions by a driving device (not shown) using a motor or the like as a driving source. The positions to which the first die 30 and the second die 40 are to be moved are determined on the basis of a detection result from an image processing device (not shown).

First, in a preparation step, the ground electrode 20 having the first end portion 21 joined to the metal shell 17 is prepared. In the present embodiment, the metal shell 17 having the ground electrode 20 joined thereto is assembled to the outer circumference of the insulator 11. Then, the ground electrode 20 is disposed between the first die 30 and the second die 40 in a state of extending in the direction of the axial line O from the first end portion 21 toward the second end portion 22. By the first die 30 and the second die 40 being pressed against the ground electrode 20, the second end portion 22 side opposite to the first end portion 21 joined to the metal shell 17 is bent with the inner surface 23 being an inner side.

The first die 30 is a member to be pressed against the inner surface 23 of the ground electrode 20, and the second die 40 is a member to be pressed against the outer surface 24 of the ground electrode 20. The first die 30 has: an end portion 31 to be pressed against the inner surface 23 of the ground electrode 20; a curved portion 32 being contiguous to the end portion 31 and bulging outward; and a flat surface portion 33 contiguous to the curved portion 32. The end portion 31 is a flat surface parallel to the axial line O. The flat surface portion 33 is a flat surface that is tilted to the first end portion 21 side (lower side in FIG. 2), toward the inner surface 23 of the ground electrode 20. An angle θ at an intersection point between a tangent line 36 of the end portion 31 and a tangent line 37 of the flat surface portion 33 is 0°<θ<90°.

The widths (dimensions in a direction perpendicular to the drawing sheet of FIG. 2) of the end portion 31, the curved portion 32, and the flat surface portion 33 of the first die 30 are each larger than the width (dimension in a direction perpendicular to the drawing sheet of FIG. 2) of the ground electrode 20. A boundary 34 between the end portion 31 and the curved portion 32, and a boundary 35 between the curved portion 32 and the flat surface portion 33 are straight lines extending in the width direction of the first die 30. The boundaries 34, 35 are parallel to each other.

The second die 40 is a roller rotatable about a shaft 41. The shaft 41 is disposed on the front side (upper side in FIG. 2) in the direction of the axial line O relative to the flat surface portion 33 of the first die 30. The shaft 41 is elastically supported by a spring 42. When the second die 40 presses the ground electrode 20 against the flat surface portion 33 of the first die 30, the spring 42 energizes the second die 40 to the rear side (first die 30 side) in the direction of the axial line O. The width in the axial direction (direction perpendicular to the drawing sheet of FIG. 2) of the second die 40 is larger than the width (dimension in a direction perpendicular to the drawing sheet of FIG. 2) of the ground electrode 20. The shaft 41 is disposed to be parallel to the boundaries 34, 35. In the present embodiment, the diameter of the second die 40 (roller) is longer than the length in the direction of the axial line O of the ground electrode 20.

For the ground electrode 20, in a first step of a bending step, the first die 30 is pressed against the inner surface 23 of the ground electrode 20, and thereafter, in a second step of the bending step, the second die 40 is pressed against the outer surface 24 of the ground electrode 20. The ground electrode 20 is bent between the first die 30 and the second die 40 so as to be fitted along the first die 30.

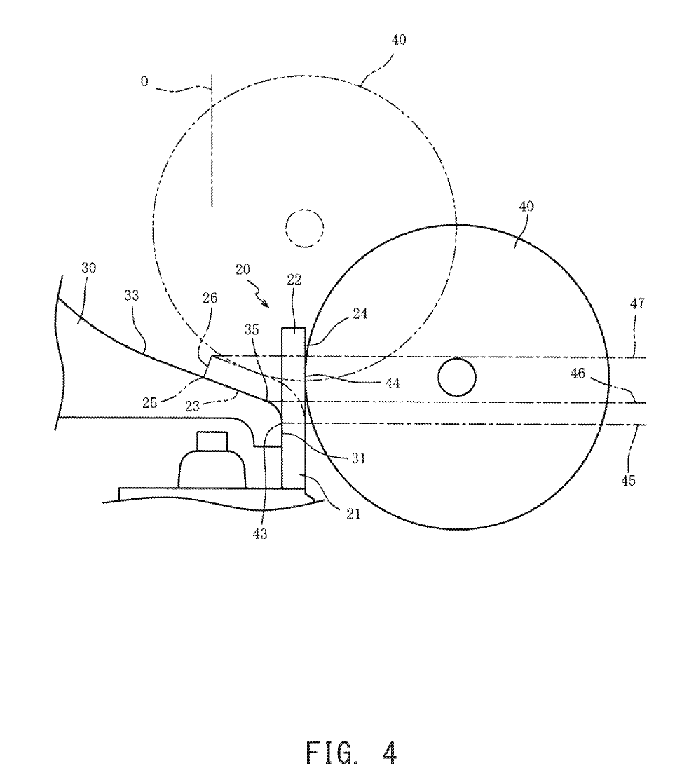

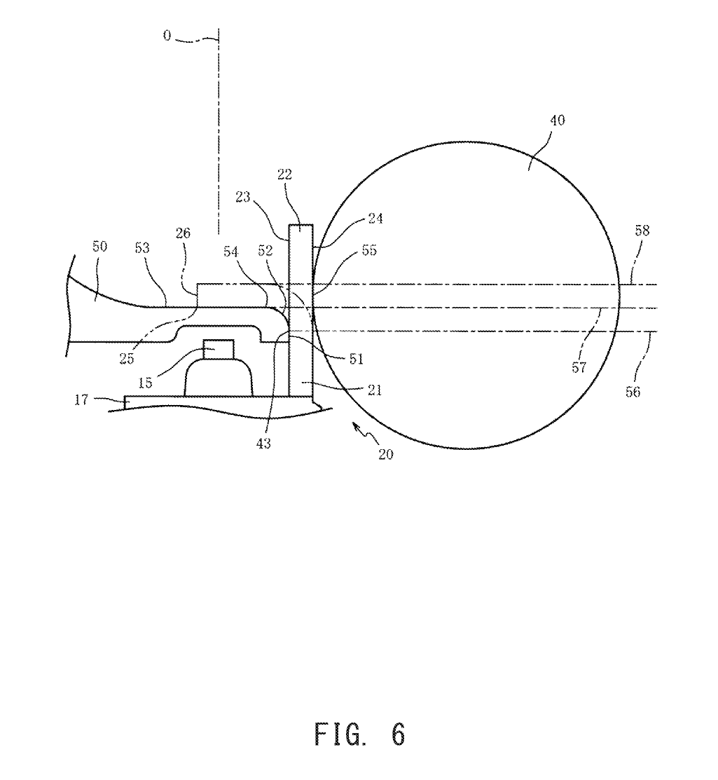

FIG. 3 is a side view of the first die 30 of which the end portion 31 is pressed against the ground electrode 20, and the second die 40. In FIG. 3, the spring 42 is not shown (the same applies to FIG. 4 and FIG. 6). As shown in FIG. 3, in the first step of the bending step, the image processing device (not shown) detects the positions and the sizes of the center electrode 15 and the ground electrode 20, and, on the basis of a result of the detection, the end portion 31 of the first die 30 is pressed against the inner surface 23 of the ground electrode 20 while avoiding the center electrode 15. A position 43 at which the boundary 34 of the end portion 31 of the first die 30 comes into contact with the inner surface 23 at this time, is present on the first end portion 21 side relative to an end 25 on the second end portion 22 side of the inner surface 23 of the ground electrode 20.

FIG. 4 is a side view of the first die 30 and the second die 40 pressed against the ground electrode 20. As shown in FIG. 4, in the second step of the bending step, the second die 40 is linearly moved in a direction (arrow direction in FIG. 4) orthogonal to the axial line O, and the second die 40 is pressed against the outer surface 24 of the ground electrode 20. Since the end portion 31 of the first die 30 is being pressed against the inner surface 23 of the ground electrode 20, a starting point from which the ground electrode 20 starts to be bent is determined in accordance with the end portion 31.

A position 44 at which the second die 40 is first pressed against the ground electrode 20 is a position that is closer, in the direction of the axial line O (up/down direction in FIG. 4), to the second end portion 22 than the position at which the end portion 31 of the first die 30 is pressed against the ground electrode 20. That is, the position 44 at which the second die 40 is first pressed against the ground electrode 20 is present on the front side (upper side in FIG. 4) in the direction of the axial line O relative to the position 43 (first position 45) of the boundary 34 (see FIG. 3) on the first die 30. Therefore, the ground electrode 20 can be prevented from being squashed in the thickness direction between the end portion 31 of the first die 30 and the second die 40 when the second die 40 is first pressed against the ground electrode 20.

The second die 40 is moved in a state where the end portion 31 of the first die 30 is pressed against the ground electrode 20, and the second die 40 is brought relatively close to the flat surface portion 33 of the first die 30, so that the ground electrode 20 is bent so as to be fitted along the curved portion 32 with the end portion 31 of the first die 30 acting as a fulcrum. The position 44 at which the second die 40 is first pressed against the ground electrode 20 is a position that is closer, in the direction of the axial line O, to the second end portion 22 than a position (second position 46) of the boundary 35 between the curved portion 32 and the flat surface portion 33.

In this case, the distance between the end portion 31 of the first die 30 and the position 44 at which the second die 40 is pressed, can be elongated as compared to a case where the position 44 at which the second die 40 is first pressed against the ground electrode 20 is present on the first end portion 21 side (lower side in FIG. 4) in the direction of the axial line O relative to the position (second position 46) of the boundary 35 between the curved portion 32 and the flat surface portion 33. Therefore, the ground electrode 20 can be easily bent with less force, with: the first end portion 21 acting as the point of load; the end portion 31 acting as the fulcrum; and the position 44 acting as the point of effort.

Then, the second die 40 is moved along the curved portion 32 and the flat surface portion 33 of the first die 30 while being apart therefrom by a distance (thickness of the ground electrode 20) between the outer surface 24 and the inner surface 23 of the ground electrode 20. Such a movement is enabled because the second die 40 can be moved to an arbitrary position by the driving device (not shown) using a motor or the like as a driving source. The second die 40 is rolled on the outer surface 24 of the ground electrode 20 from the position 44 toward the second end portion 22 while gradually increasing the area of contact between the ground electrode 20 and the first die 30, by the second die 40 moving so as to bend the ground electrode 20.

The position 44 at which the second die 40 is first pressed against the ground electrode 20 in the second step is a position that is closer to the first end portion 21 than a position 47 (third position) in the direction of the axial line O at which an end 26 on the second end portion 22 side of the ground electrode 20 is to be located when the entirety of a part, of the inner surface 23 of the ground electrode 20, from a position of contact with the end portion 31 of the first die 30 to the end 26 on the second end portion 22 side comes into contact with the first die 30. As a result, by the second die 40 being moved relative to the first die 30, the ground electrode 20 can be pressed against the first die 30 sequentially from the first end portion 21 side to the second end portion 22 side. The ground electrode 20 can be bent with high accuracy so as to be fitted along the first die 30, whereby the ground electrode 20 bent so as to be fitted along the first die 30 has substantially accurately reproduced shapes of the curved portion 32 and the flat surface portion 33 of the first die 30. Therefore, variation in the shape of the ground electrode 20 to be produced in the bending step can be reduced.

When the second die 40 presses the ground electrode 20 against the flat surface portion 33 of the first die 30, the spring 42 elastically supporting the shaft 41 of the second die 40 energizes the second die 40 to the rear side (first die 30 side) in the direction of the axial line O. Therefore, load being applied by the second die 40 in the thickness direction of the ground electrode 20 pressed against the flat surface portion 33 of the first die 30 can be adjusted in accordance with the deformation amount of the spring 42. As a result, moderate load can be applied to the ground electrode 20 such that the ground electrode 20 sandwiched between the first die 30 and the second die 40 is not excessively squashed.

In addition, since the second die 40 is a roller rotatable about the shaft 41, the second die 40 is rolled on the outer surface 24 of the ground electrode 20. Therefore, scratches due to friction between the second die 40 and the ground electrode 20 can be made less likely to be formed on the outer surface 24 of the ground electrode 20. Therefore, machining marks can be prevented from being left on the outer surface 24 of the ground electrode 20. Furthermore, since the diameter of the second die 40 (roller) is longer than the length in the direction of the axial line O of the ground electrode 20, recesses can be made less likely to be formed in the ground electrode 20 when the second die 40 comes into contact with the ground electrode 20.

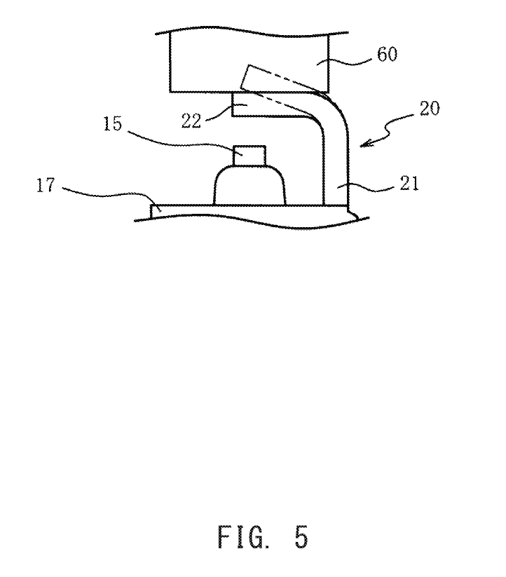

In order to adjust the size of the spark gap between the ground electrode 20 and the center electrode 15, a third die 60 further bends the ground electrode 20 bent by the second die 40 so as to be fitted along the first die 30, by the bending step. FIG. 5 is a side view of the ground electrode 20 with the spark gap being adjusted.

As shown in FIG. 5, the third die 60 presses the second end portion 22 side of the ground electrode 20 in the direction of the axial line O (up/down direction in FIG. 5), so as to adjust the size of the spark gap in consideration of the springback amount of the ground electrode 20 and the like. The third die 60 deforms the ground electrode 20 so as to further deeply bend the bent portion of the ground electrode 20. A starting point of the bending when the ground electrode 20 is pressed by the third die 60 is substantially identical to the starting point from which the ground electrode 20 is bent and which is determined in accordance with the end portion 31 of the first die 30, in the bending step described above.

Since it is possible to reduce variation in the position of the starting point from which the ground electrode 20 starts to be bent in the bending step, variation in the shape of the ground electrode 20 to be produced in the bending step can be reduced. If the shape of the ground electrode 20 varies, variation in the springback amount of the ground electrode 20 pressed by the third die 60 increases, so that it is impossible to reduce a dimensional tolerance for the spark gap. On the other hand, according to the present embodiment, since variation in the shape of the ground electrode 20 to be produced in the bending step can be reduced, variation in the springback amount of the ground electrode 20 pressed by the third die 60 can be reduced. Therefore, the dimensional tolerance for the spark gap can be reduced.

Next, a second embodiment will be described with reference to FIG. 6. In the first embodiment, the case where the flat surface portion 33 of the first die 30 is formed so as to be tilted relative to the axial line O has been described. On the other hand, in the second embodiment, a case where a flat surface portion 53 of a first die 50 is formed so as to be orthogonal to the axial line O will be described. The same components as the components described in the first embodiment are denoted by the same reference numerals, and the description thereof is omitted. FIG. 6 is a side view of the first die 50 and the second die 40 according to the second embodiment. In FIG. 6, the shaft 41 of the second die 40 is not shown.

As shown in FIG. 6, the first die 50 has: an end portion 51 to be pressed against the inner surface 23 of the ground electrode 20; a curved portion 52 being contiguous to the end portion 51 and bulging outward; and the flat surface portion 53 contiguous to the curved portion 52. The end portion 51 is a flat surface parallel to the axial line O. The flat surface portion 53 is a flat surface orthogonal to the axial line O.

In the bending step, first, the end portion 51 of the first die 50 is pressed against the inner surface 23 of the ground electrode 20 while the first die 50 is avoiding the center electrode 15. The position 43 at which the boundary between the end portion 51 and the curved portion 52 of the first die 50 comes into contact with the inner surface 23 of the ground electrode 20 at this time, is present on the first end portion 21 side relative to the end 25 on the second end portion 22 side of the inner surface 23 of the ground electrode 20.

Then, the second die 40 is pressed against the outer surface 24 of the ground electrode 20. A position 55 at which the second die 40 is first pressed against the ground electrode 20 is present on the front side (upper side in FIG. 6, i.e., the second end portion 22 side of the ground electrode 20) in the direction of the axial line O relative to the position 43 (first position 56), on the ground electrode 20, in the direction of the axial line O and relative to the position (second position 57) of a boundary 54 between the curved portion 52 and the flat surface portion 53 of the first die 50. Furthermore, the position 55 at which the second die 40 is first pressed against the ground electrode 20 is present on the first end portion 21 side (lower side in FIG. 6) relative to a third position 58 in the direction of the axial line O at which the end 26 on the second end portion 22 side of the ground electrode 20 is to be located when the entirety of a part, of the inner surface 23 of the ground electrode 20, to the end 25 on the second end portion 22 side from the position 43 at which the end portion 51 of the first die 50 and the ground electrode 20 are in contact with each other comes into contact with the first die 50. Accordingly, the same advantageous effects as those in the first embodiment can be achieved.

The third die 60 (see FIG. 5) presses, in the direction of the axial line O, the ground electrode 20 bent by the second die 40 so as to be fitted along the first die 50, by the bending step, so that the size of the spark gap between the ground electrode 20 and the center electrode 15 is adjusted. The starting point of the bending when the ground electrode 20 is pressed by the third die 60 is substantially identical to the starting point from which the ground electrode 20 is bent and which is determined in accordance with the end portion 51 of the first die 50, in the bending step described above. Since it is possible to reduce variation in the position of the starting point from which the ground electrode 20 starts to be bent by the bending step, the dimensional tolerance for the spark gap due to the variation can be reduced, as in the first embodiment.

As described above, although the present invention has been described based on the embodiments, the present invention is not limited to the above-described embodiments at all. It can be easily understood that various modifications can be devised without departing from the gist of the present invention. For example, the shape and the size of the first die 30, 50, the size of the second die 40 (the diameter of the roller), and the like are set, as appropriate, in accordance with the size of the spark plug 10, the shape of the ground electrode 20, and the like.

In the embodiments, the case where the ground electrode 20 having no noble-metal-containing tip joined thereto is bent has been described, but the present invention is not necessarily limited thereto. As a matter of course, the tip may be joined to the inner surface 23 of the ground electrode 20 at the second end portion 22 side in order to improve spark wear resistance of the ground electrode 20. In the case where the tip is joined to the inner surface 23 of the ground electrode 20, a hole, a groove, a recess, or the like housing the tip is formed in the flat surface portion 33, 53 of the first die 30, 50 such that the tip does not collide with the flat surface portion 33, 53 of the first die 30, 50 with which the inner surface 23 of the ground electrode 20 is to come into contact.

In the embodiments, the case where the position of the ground electrode 20 is fixed and the first die 30, 50 and the second die 40 are moved has been described, but the present invention is not necessarily limited thereto. For example, as a matter of course, the position of the first die 30, 50 may be fixed and the ground electrode 20 and the second die 40 may be moved relative to the first die 30, 50. Alternatively, as a matter of course, the position of the second die 40 may be fixed and the ground electrode 20 and the first die 30, 50 may be moved relative to the second die 40. This is because the positional relationship among the ground electrode 20, the first die 30, 50, and the second die 40 is a relative one.

In the embodiments, the case where the shaft 41 of the second die 40 is elastically supported by the spring 42 has been described, but the present invention is not necessarily limited thereto. As a matter of course, with no spring 42 being provided, the size of the space between the second die 40 and the flat surface portion 33, 53 of the first die 30, 50 may be adjusted by a driving device (not shown) such that the ground electrode 20 is not excessively squashed in consideration of the thickness of the ground electrode 20 bent so as to be fitted along the first die 30, 50.

In the embodiments, the case where the second die 40 first comes into contact with a portion between the second position 46, 57 and the third position 47, 58 on the ground electrode 20 in the bending step has been described, but the present invention is not necessarily limited thereto. The position at which the second die 40 first comes into contact with the ground electrode 20 may be set, as appropriate, between the first position 45, 56 and the end 26 of the ground electrode 20 in accordance with the length of the ground electrode 20, the size of the second die 40 (the diameter of the roller), or the like.

### DESCRIPTION OF REFERENCE NUMERALS

10: spark plug
11: insulator
12: axial hole
15: center electrode
17: metal shell
18: tube hole
20: ground electrode
21: first end portion
22: second end portion
23: inner surface
24: outer surface
25: end of inner surface
26: end of ground electrode
30, 50: first die
31, 51: end portion
32, 52: curved portion
33, 53: flat surface portion
35, 54: boundary
40: second die
44, 55: position at which second die is first pressed
45: part
47, 58: third position (position of end of ground electrode)
O: axial line

Having described the invention, the following is claimed:

1. A method for manufacturing a spark plug including: a tubular metal shell extending in a direction of an axial line from a front side toward a rear side; an insulator disposed in a tube hole of the metal shell and holding a center electrode at the front side; and a rod-like ground electrode having a first end portion joined to a front end portion of the metal shell, and having a second end portion bent to an axial line side so as to be opposed to the center electrode, the method comprising:
a preparation step of preparing the metal shell having the ground electrode joined thereto; and
a bending step of bending the ground electrode joined to the metal shell, along a first die to the axial line side, wherein
the first die has an end portion to be pressed against an inner surface of the ground electrode, and a flat surface portion contiguous to the end portion via a curved portion bulging outward,
the flat surface portion is formed so as to be orthogonal to the axial line or so as to be tilted to a first end portion side, toward the inner surface of the ground electrode, and
the bending step includes a first step of pressing the end portion of the first die against the ground electrode.

2. The method for manufacturing the spark plug according to claim 1, the method further comprising
a second step of bending the ground electrode by using a second die which is a roller to be rolled on an outer surface, of the ground electrode, which is a surface on a side opposite to the inner surface toward the second end portion while pressing the outer surface, such that the ground electrode is fitted along the flat surface portion with the end portion of the first die acting as a fulcrum, wherein
a position at which the second die is first pressed against the ground electrode in the second step is a position that is closer, in the direction of the axial line, to the second end portion than a position at which the end portion of the first die is pressed.

3. The method for manufacturing the spark plug according to claim 2, wherein
the position at which the second die is first pressed against the ground electrode in the second step is a position that is closer, in the direction of the axial line, to the second end portion than a boundary between the curved portion and the flat surface portion.

4. The method for manufacturing the spark plug according to claim 2, wherein
the position at which the second die is first pressed against the ground electrode in the second step is a position that is closer to the first end portion than a position in the direction of the axial line at which an end on a second end portion side of the ground electrode is to be located when an entirety of a part, of the inner surface of the ground electrode, from a position of contact with the end portion of the first die to an end on the second end portion side comes into contact with the first die.

5. The method for manufacturing the spark plug according to claim 3, wherein
the position at which the second die is first pressed against the ground electrode in the second step is a position that is closer to the first end portion than a position in the direction of the axial line at which an end on a second end portion side of the ground electrode is to be located when an entirety of a part, of the inner surface of the ground electrode, from a position of contact with the end portion of the first die to an end on the second end portion side comes into contact with the first die.
